(19) United States
(12) Patent Application Publication
(10) Pub. No.: US 2025/0067237 A1
(43) Pub. Date: Feb. 27, 2025

(54) APPARATUS, SYSTEM, AND METHOD FOR PROVIDING PRESSURIZED AIR VIA AN ENGINE

(71) Applicant: Toyota Motor Engineering & Manufacturing North America, Inc., Plano, TX (US)

(72) Inventors: Paxton S. Williams, Milan, MI (US); Colby S. Williams, Saline, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/236,914

(22) Filed: Aug. 22, 2023

(51) Int. Cl. F02M 67/04; B60K 13/04

(52) U.S. Cl. CPC F02M 67/04; B60K 13/04; F02M 2700/126

(57) ABSTRACT

Apparatuses, systems, and methods for providing pressurized air from a vehicle. The apparatus includes an engine block including a plurality of cylinders, a plurality of pistons each disposed within a respective one of the plurality of cylinders, a crankshaft rotatably mounted on the engine block, a plurality of connecting rods each having a first end and a second end, the first end rotatably connected to the crankshaft and the second end coupled to a respective one of the plurality of pistons, a fuel and air mixture intake line in communication with at least one cylinder of the plurality of cylinders, an air intake line in communication with the at least one cylinder, an exhaust line in communication with the at least one cylinder, a switch, and a switch controller. The switch controller may cause the switch to switch between a fuel and air mixture configuration and an air-only configuration.

### BACKGROUND

### Field

The present disclosure relates to apparatuses, systems, and methods for providing pressurized air from a vehicle via an engine.

### Description of the Related Art

Conventional air pump units may attach to a vehicle by, e.g., PTO (Power Take-off) or by running belts to a pulley system on an engine to provide pressurized or compressed air. There are many uses for the pressurized or compressed air (e.g., from the conventional air pump units) when a driver is traveling (e.g., on an off-road trip). Examples of such uses of the pressurized or compressed air include enabling a differential lock, filling air into tires, setting up an air mattress, or the like. The conventional air pump units that may provide the pressurized or compressed air in these examples may be an accessory to the vehicle—i.e., an external air pump or a mounted air pump. However, carrying or installing one or more such conventional air pump units on the vehicle requires a lot of space within or on the vehicle—space which may otherwise be used to store other items within or on the vehicle for various purposes. Additionally, such conventional air pump units may cause much inconvenience by requiring a separate source of power and/or bulky wiring to power the air pump units.

Hence, there is a need for apparatuses, systems, and methods for providing pressurized air from a vehicle, e.g., without requiring a separate air pump unit carried or mounted on or within the vehicle.

### SUMMARY

Described herein is an apparatus for providing pressurized air from a vehicle. The apparatus may include an engine block. The engine block may include a plurality of cylinders. The apparatus may include a plurality of pistons. Each of the plurality of pistons may be disposed within a respective one of the plurality of cylinders. The apparatus may include a crankshaft. The crankshaft may be rotatably mounted on the engine block. The apparatus may include a plurality of connecting rods. Each of the plurality of connecting rods may have a first end and a second end. The first end may be rotatably connected to the crankshaft. The second end may be coupled to a respective one of the plurality of pistons. The apparatus may include a fuel and air mixture intake line in communication with at least one cylinder of the plurality of cylinders. The apparatus may include an air intake line in communication with the at least one cylinder. The apparatus may include an exhaust line in communication with the at least one cylinder. The apparatus may include a switch. The switch may switch between a fuel and air mixture configuration and an air-only configuration. The fuel and air mixture configuration may correspond to a first switch configuration that allows a fuel and air mixture to be provided to the at least one cylinder via the fuel and air mixture intake line to enable a combustion. The air-only configuration may correspond to a second switch configuration that allows only air to be provided to the at least one cylinder via the air intake line to generate the pressurized air within the at least one cylinder to be provided via the exhaust line. The apparatus may include a switch controller. The switch controller may be connected to the switch. The switch controller may be configured to cause the switch to switch between the fuel and air mixture configuration and the air-only configuration based on a user input.

Also described is a system for providing pressurized air from a vehicle. The system may include an engine. The engine may include an engine block. The engine block may include a plurality of cylinders. The plurality of cylinders may have, respectively, a plurality of pistons therein. The engine may include a crankshaft. The crankshaft may be rotatably mounted on the engine block. The engine may include a plurality of connecting rods. Each of the plurality of connecting rods may have a first end and a second end. The first end may be rotatably connected to the crankshaft. The second end may be coupled to a respective one of the plurality of pistons. The engine may include a fuel and air mixture intake line in communication with at least one cylinder of the plurality of cylinders. The engine may include an air intake line in communication with the at least one cylinder. The engine may include an exhaust line in communication with the at least one cylinder. The system may include a switch. The switch may switch between a fuel and air mixture configuration and an air-only configuration. The fuel and air mixture configuration may correspond to a first switch configuration that allows a fuel and air mixture to be provided to the at least one cylinder via the fuel and air mixture intake line to enable a combustion. The air-only configuration may correspond to a second switch configuration that allows only air to be provided to the at least one cylinder via the air intake line to generate the pressurized air within the at least one cylinder to be provided via the exhaust line. The system may include an electronic control unit (ECU) on or within the vehicle. The ECU may be connected to the engine and the switch. The ECU may be configured to cause the switch to switch between the fuel and air mixture configuration and the air-only configuration based on a user input.

Moreover, also described is a method for providing pressurized air from a vehicle. The method may include receiving, by a user interface, a user input indicative of a user instruction to control a switch to switch from a first switch configuration to a second switch configuration. The switch may be connected to a fuel and air mixture intake line and an air intake line each in communication with at least one cylinder of a plurality of cylinders. The plurality of cylinders may be included in an engine block. Each of the plurality of cylinders may have a piston disposed therein. The first switch configuration may correspond to a fuel and air mixture configuration that allows a fuel and air mixture to be provided to the at least one cylinder via the fuel and air mixture intake line to enable a combustion. The second switch configuration may correspond to an air-only configuration that allows only air to be provided to the at least one cylinder via the air intake line to generate the pressurized air within the at least one cylinder to be provided via an exhaust line in communication with the at least one cylinder. The method may include actuating, by a controller, the switch to switch from the first switch configuration to the second switch configuration in response to receiving the user input such that the pressurized air from the at least one cylinder is provided via the exhaust line as a crankshaft rotatably mounted on the engine block is rotated to provide the air to the at least one cylinder via the air intake line, pressurize the air within the at least one cylinder, and release the pressurized air from the at least one cylinder via the exhaust line.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale, and may be exaggerated to better illustrate the important features of the present invention. In the drawings, like reference numerals designate like parts throughout the different views, wherein:

FIG. 1 is a block diagram of a system for providing pressurized air from a vehicle according to an embodiment of the present invention;

FIG. 2 is an illustration of a system for providing pressurized air from a vehicle according to an embodiment of the present invention;

FIG. 3 is an illustration of a system for providing pressurized air from a vehicle according to an embodiment of the present invention;

FIG. 4 is an illustration of a system for providing pressurized air from a vehicle according to an embodiment of the present invention; and

FIG. 5 is a flowchart illustrating a method for providing pressurized air from a vehicle according to an embodiment of the present invention.

### DETAILED DESCRIPTION

The present disclosure describes apparatuses, systems, and methods for providing pressurized (i.e., compressed) air from a vehicle via an engine. The apparatuses, systems, and methods described herein provide many benefits and advantages including providing pressurized air from a vehicle without requiring a separate air compressor unit such as, e.g., an air pump, a separate source of power, or any added wiring to, e.g., power the apparatuses, systems, and methods for providing the pressurized air from the vehicle.

The apparatuses, systems, and methods described herein utilize one or more cylinders within an internal combustion engine to generate pressurized or compressed air for a driver or the vehicle to use. For example, while one or more other cylinders may be firing with a fuel and air mixture to turn on the engine, the one or more cylinders utilized by the apparatuses, systems, and methods described herein to generate the pressurized air can receive air without any fuel mixed in the air, pressurize the received air within the one or more cylinders based on the movement of one or more pistons disposed, respectively, within the one or more cylinders, and release the pressurized air for the driver or the vehicle to use. That is, these one or more cylinders within the engine may be temporarily used to create the pressurized air for the driver or the vehicle to use as described herein while the other one or more cylinders (wherein the fuel and air mixture may still be ignited to generate the combustion) may still be being used to turn on the engine.

The pressurized air supply prepared as described herein can be used by the vehicle for many purposes including filling air into tires, e.g., after traveling in off-road conditions (which may include releasing air from the tires to improve tire traction), operating various pneumatically powered vehicle parts such as, e.g., differential lock devices, pressurizing a water system to provide a pressurized water supply, filling up an air mattress, powering air-powered tools such as, e.g., air grinders, air pencils, air hammers, air drills, air impact wrenches, or the like, etc. These capabilities can be made available for the vehicle without adding unwanted weight or taking up extra space to support a separate air compressor unit.

Additionally, the apparatuses, systems, and methods described herein may utilize one or more cylinders within an internal combustion engine to generate pressurized or compressed air while a vehicle is decelerating. That is, as the one or more cylinders stop firing with a fuel and air mixture (thus not contributing meaningfully to propelling the vehicle) as the vehicle is decelerating, the unused fuel can be saved to be used later (e.g., extending a drivable range of the vehicle). In this way, the apparatuses, systems, and methods described herein can “regenerate” fuel and/or pressurized air for a future use.

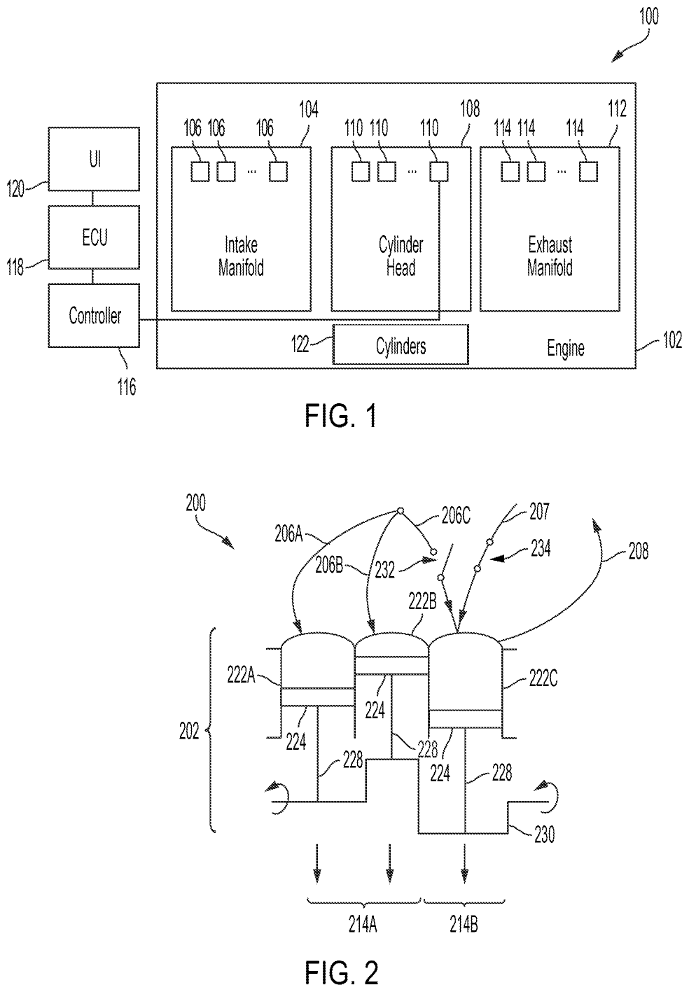

Turning to FIG. 1, a system (or apparatus) 100 for providing pressurized air from a vehicle is described.

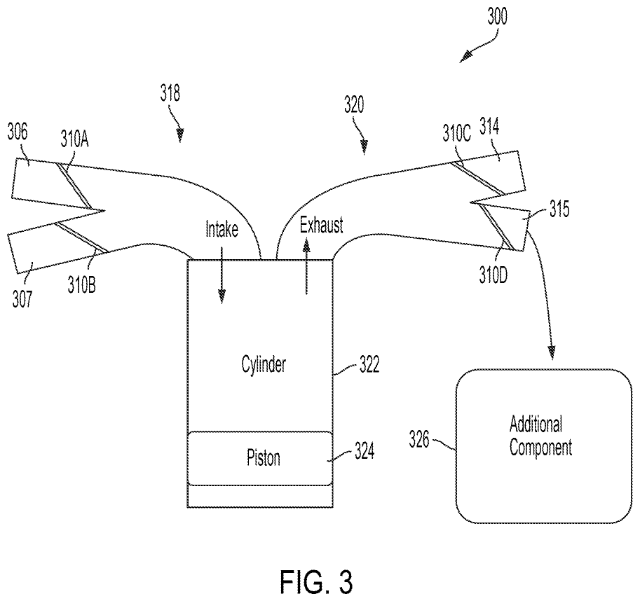

The system 100 includes an engine (or an engine block) 102. The system 100 or the engine 102 may include a cylinder head 108, an intake manifold 104, and an exhaust manifold 112. The intake manifold 104 and the exhaust manifold 112 may include, respectively, a plurality of intake lines 106 and a plurality of exhaust lines 114. In various embodiments, each line of the plurality of intake lines 106 and the plurality of exhaust lines 114 may be a tube, a pipe, or the like configured for carrying gas (e.g., a fuel and air mixture or just air). The cylinder head 108 may include a plurality of connecting portions 110 that may provide a plurality of connections between a plurality of cylinders 122 and, respectively, the plurality of intake lines 106 and the plurality of exhaust lines 114. As described herein, the plurality of connecting portions 110 may include or be connected to one or more switches (similar to a first switch 232 and/or a second switch 234 shown in and described herein with respect to FIG. 2) and/or one or more valves (similar to, e.g., a plurality of valves 310A-D shown in and described herein with respect to FIG. 3) to control a flow of the fuel and air mixture or the air between the plurality of cylinders 122 and, respectively, the plurality of intake lines 106 and the plurality of exhaust lines 114. The one or more switches and/or the one or more valves may be connected to and controlled by a controller 116 (which may be or include, e.g., a switch controller or a valve controller) included in the system 100.

In various embodiments, the controller 116 may be connected to and controlled by an electronic control unit (ECU) 118 included in the system 100. The ECU 118 may be an ECU on or within a vehicle wherein the system 100 for providing the pressurized air may be implemented. The controller 116 and/or the ECU 118 may include or couple to one or more processors. These one or more processors may be implemented as a single processor or as multiple processors. For example, the controller 116 and/or the ECU 118 may be or include a microprocessor, a data processor, a microcontroller, or other controller, and may be electrically coupled to at least a user interface (UI) 120. The controller 116 and/or the ECU 118 may be a dedicated controller and/or ECU configured to control the one or more switches and/or the one or more valves or may be coupled to or be a part of another controller and/or ECU which controls other devices or vehicle components, too.

In various embodiments, the ECU 118 may be connected to and controlled by the UI 120. The UI 120 may include an input device and/or an output device which may be disposed on or within the vehicle and thus be a local UI. In some embodiments, the UI 120 may be available on a remote device such as, e.g., a mobile device of a driver or user of the vehicle. For example, the driver or user may run a software program application on the mobile device which may allow the driver or user to activate a vehicle mode or provide an indication or instruction to, e.g., switch the one or more switches and/or the one or more valves within the system 100 or the engine 102 and connected to the controller 116 from a fuel and air mixture configuration to an air-only configuration to generate and provide the pressurized air from the vehicle. In some embodiments, the UI 120 may be a UI device attached to or integrated within the vehicle (e.g., an infotainment system or the like). In some embodiments, the UI 120 may be a UI available on a remote device such as, e.g., a smartphone, a tablet, or the like which may be connected to the system 100 or the vehicle via wire or wirelessly (the wireless connection being provided by any type of wireless connection known in the art such as, for example, Bluetooth, Wi-Fi, a cellular network, etc.).

The input device may include one or more input devices such as a button, a keyboard, a mouse, a touchscreen, a microphone, or the like. The input device may receive input from the driver or user of the vehicle such as a driver or a passenger. The input device may receive, for example, information corresponding to a request to activate a vehicle mode or provide an indication or instruction to, e.g., switch the one or more switches and/or the one or more valves within the system 100 or the engine 102 and connected to the controller 116 from the fuel and air mixture configuration to the air-only configuration to generate and provide the pressurized air from the vehicle. Moreover, in some embodiments, the input device may include a button (e.g., a physical button on or within the vehicle and/or a “soft” button on a UI such as a touchscreen display). The output device may include any output device such as a speaker, a display, a touchscreen, or the like. The output device may output data to the driver or user of the vehicle. For example, the output device may output information relating to a current status of the vehicle mode and/or a current configuration of the one or more switches and/or the one or more valves (i.e., between the fuel and air mixture configuration and the air-only configuration).

Referring now to FIG. 2, a system (or apparatus) 200 for providing pressurized air from a vehicle is described.

FIG. 2 is an illustration of the system 200 for providing the pressurized air from the vehicle. The system 200 may include an engine (or an engine block) 202 (similar to the engine or engine block 102 shown in and described herein with respect to FIG. 1). The engine 202 may include a plurality of cylinders 222A-C (similar to the plurality of cylinders 122 shown in and described herein with respect to FIG. 1). The engine 202 may include a plurality of pistons 224 each disposed within a respective one of the plurality of cylinders 222A-C. As an aside, it would be apparent to one of ordinary skill in the art that the apparatuses, systems, and methods described herein may utilize an engine of various types of engines of different capacities—that is, including 4-cylinder engines, 6-cylinder (“V6”) engines, 8-cylinder (“V8”) engines, or the like—without departing from the spirit of the present disclosure.

Referring back to FIG. 2, the engine 202 may include a plurality of fuel and air mixture intake lines 206A-C (as well as a plurality of exhaust lines) in communication with, respectively, the plurality of cylinders 222A-C. Moreover, the engine 202 may include a crankshaft 230 rotatably mounted on the engine 202. The engine 202 may include a plurality of connecting rods 228 each having a first end and a second end. The first end may be rotatably connected to the crankshaft 230, and the second end may be coupled to a respective one of the plurality of pistons 224. In various embodiments, the crankshaft 230 may be connected to a starter motor on the vehicle configured to turn the engine 202 on or over when the engine 202 is started (i.e., to initiate the initial movement/ignition within the engine 202). After the engine 202 is started, the plurality of pistons 224 may move, e.g., up and down within the respective ones of the plurality of cylinders 222A-C (each movement of a piston along a cylinder in either direction being referred to as a “stroke” herein) to cause the crankshaft 230 to continue to turn on or rotate to generate the force (i.e., torque) to move the vehicle.

For example, the engine 202 may be a four-stroke internal combustion engine. That is, each piston 224 may complete cycles of four separate strokes to cause the crankshaft 230 to continue to turn or rotate. In the first stroke, each piston 224 may move from its top center position to its bottom center position within the respective one of the plurality of cylinders 222A-C. In this stroke, the piston 224 may pull a fuel and air mixture (e.g., via a corresponding fuel and air mixture intake line) into the respective one of the plurality of cylinders 222A-C by producing a partial vacuum in the cylinder through the downward motion of the piston 224. In the second stroke, the piston 224 may move from the bottom center position to the top center position. In this stroke, the piston 224 may compress the fuel and air mixture within the respective one of the plurality of cylinders 222A-C (e.g., with openings to the corresponding fuel and air intake line and the corresponding exhaust line being closed) in preparation for ignition during the next stroke. In the third stroke, the compressed fuel and air mixture may be ignited, e.g., by a spark plug connected to the respective one of the plurality of cylinders 222A-C (in a gasoline engine) or by heat generated by high compression (in a diesel engine) to cause the piston 224 to move back to the bottom center position. In the fourth stroke, the piston 224 may move back to the top center position to release the compressed fuel and air mixture out of the respective one of the plurality of cylinders 222A-C (e.g., via the corresponding exhaust line).

In various embodiments, the engine 202 may include an air intake line 207 as well as an exhaust line 208 in communication with at least one cylinder 222C. The engine 202 may include one or more switches (e.g., a first switch 232 and a second switch 234) that switch between a fuel and air mixture configuration and an air-only configuration. In some embodiments, the first switch 232 and the second switch 234 may be separate switches controlled separately. In some embodiments, the first switch 232 and the second switch 234 may be part of a single switch system. The fuel and air mixture configuration may correspond to a first switch configuration that allows a fuel and air mixture to be provided to the at least one cylinder 222C via the fuel and air mixture intake line 206C to enable a combustion. The air-only configuration may correspond to a second switch configuration that allows only air to be provided to the at least one cylinder 222C via the air intake line 207 to generate the pressurized air within the at least one cylinder 222C to be provided via the exhaust line 208. The system 200 may include a switch controller (e.g., the controller 116 shown in and described herein with respect to FIG. 1) connected to the one or more switches (e.g., the first switch 232 and the second switch 234) and configured to cause the one or more switches to switch between the fuel and air mixture configuration and the air-only configuration based on a user input (which may be received via an input/output device such as, e.g., the UI 120 shown in and described herein with respect to FIG. 1).

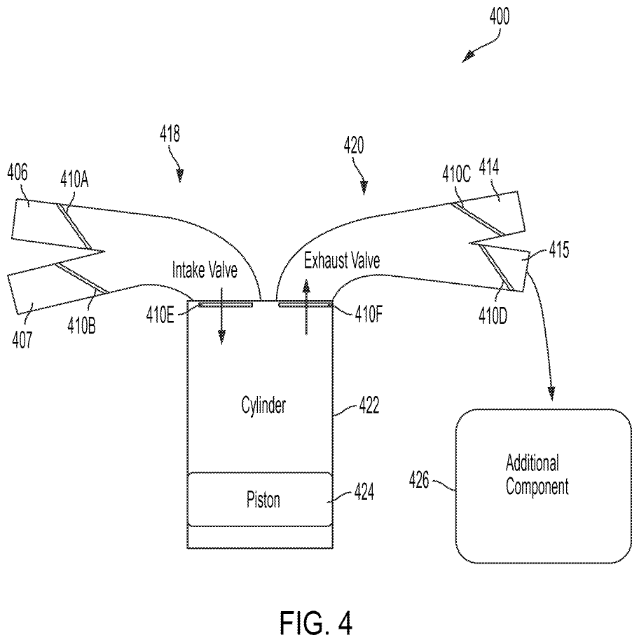

For the fuel and air mixture configuration, the first switch 232 may be closed and the second switch 234 may be open to allow only a fuel and air mixture to be provided to the at least one cylinder 222C. In this configuration, all of the plurality of cylinders 222A-C may operate as described herein (e.g., as part of the four-stroke internal combustion engine operation) to cause the crankshaft 230 to continue to turn or rotate after the engine 202 is started to generate the force to move the vehicle. However, when the user input is received for the air-only configuration (e.g., for the at least one cylinder 222C), the first switch 232 may be opened, and the second switch 234 may be closed to activate the air-only configuration to allow only air to be provided to the at least one cylinder 222C. As described herein (e.g., with respect to FIGS. 3 and 4), the first switch 232 and the second 234 may include or be connected to one or more valves configured to open or close one or more openings at connecting portions between, e.g., the at least one cylinder 222C and, respectively, the fuel and air mixture intake line 206C, the air intake line 207, and the exhaust line 208 to control the flow of the fuel and air mixture or the air to and from the at least one cylinder 222C. These one or more valves may be controlled or actuated (e.g., by a valve controller) to open or close based on the state of the one or more switches (e.g., the first switch 232 and the second switch 234).

For the air-only configuration, pressurized air may be generated within and provided from the at least one cylinder 222C as follows. For a first stroke of the piston 224 within the at least one cylinder 222C, the piston 224 within the at least one cylinder 222C may move from its top center position to its bottom center position within the at least one cylinder 222C. In this stroke, the piston 224 may pull only air (e.g., via the air intake line 227) into the at least one cylinder 222C by producing a partial vacuum in the cylinder through the downward motion of the piston 224. In a second stroke, the piston 224 may move from the bottom center position to the top center position to release the air out of the at least one cylinder 222C via the exhaust line 228. The movement of the piston 224 within the at least one cylinder 222C pressurizes or compresses the air when the air is released via the exhaust line 228. For what would be a third stroke and a fourth stroke of a four-stroke engine, the one or more switches and/or one or more valves would be controlled such that the first stroke and the second stroke described above with respect to the flow of only the air may be repeated. In some embodiments, the engine 202 may be off (i.e., no combustion occurring), and the piston strokes may occur by another source of power (e.g., a motor such as a starter motor) providing the force to continue turning the crankshaft 230.

In various embodiments, one or more of the plurality of cylinders 222A-C (e.g., the at least one cylinder 222C) may switch to the air-only configuration while the vehicle is decelerating (or to cause the vehicle to decelerate). As the at least one cylinder 222C stops firing with any fuel and air mixture and instead is used to generate and provide the pressurized air as described herein (i.e., thus not contributing meaningfully to propelling the vehicle) when the vehicle is decelerating, the unused fuel can be saved to be used later (e.g., extending a drivable range of the vehicle). In this way, the system 200 can “regenerate” (i.e., accumulate or save) fuel and/or pressurized air for a future use. In some embodiments, the amount of the fuel and/or the pressurized air to be regenerated may be based on a user request or input. For example, the system 200 may conserve a known amount of fuel and/or accumulate a known amount of pressurized air based on a determination of a duration of the air-only configuration for the at least one cylinder 222C and/or a number of required cylinders to be in the air-only configuration for achieving the conservation of the known amount of the fuel and/or the accumulation of the known amount of the pressurized air. That is, the user request or input may include data corresponding to a requested amount of at least one of the fuel or the pressurized air to be, respectively, conserved or generated, and the switch may stay in the air-only configuration such that the requested amount of the at least one of the fuel or the pressurized air is, respectively, conserved or generated.

Accordingly, as illustrated in FIG. 2 for this scenario, the first portion 214A of the engine 202 (i.e., including the cylinders 222A and 222B connected to, respectively, the fuel and air mixture intake lines 206A and 206B) may be configured to turn the engine 202 and to generate the force or torque for moving the vehicle, while the second portion 214B of the engine 202 (i.e., including the cylinder 222C connected to the fuel and air mixture intake line 206C as well as the air intake line 207 and the exhaust line 208) may be configured to generate the force or torque for moving the vehicle and also to generate clean pressurized air for use by a driver or the vehicle based on, e.g., the state of the one or more switches (e.g., the first switch 232 and the second switch 234). In some embodiments, the second portion 214B of the engine 202 may include multiple cylinders similar to the cylinder 222C (i.e., including similar components connected to and/or disposed within the cylinder 222C and operating similarly as the cylinder 222C) described herein for generating and providing the clean pressurized air.

Turning now to FIG. 3, FIG. 3 is an illustration of a system (or an apparatus) 300 for providing pressurized air from a vehicle. The system 300 may be similar, at least in part, to the system 100 and the system 200 shown in and described herein with respect to, respectively, FIGS. 1 and 2. The system 300 may include a cylinder 322 (similar to the at least one cylinder 222C shown in and described herein with respect to FIG. 2) that may be utilized to provide the pressurized air from the vehicle. The system 300 may include a piston 324 (similar to the piston 224 disposed within the at least one cylinder 222C shown in and described herein with respect to FIG. 2) disposed within the cylinder 322. Moreover, the system 300 may include an intake line 318 and an exhaust line 320 each in communication with the cylinder 322. The intake line 318 may be used for pulling gas (e.g., the fuel and air mixture or the air) into the cylinder 322, and the exhaust line 320 may be used for expelling gas from the cylinder 322. The intake line 318 may include or be connected to a fuel and air mixture intake line 306 and an air intake line 307. The fuel and air mixture intake line 306 may be connected to, e.g., a carburetor to receive the fuel and air mixture. The air intake line 307 may be connected to a source of air (e.g., outside of the vehicle) to receive only the air to be used for generating and providing the pressurized air for use by a driver or user or the vehicle as described herein. The exhaust line 320 may include or be connected to a first exhaust line 314 and a second exhaust line 315. The first exhaust line 314 may be used to expel gas (e.g., the fuel and air mixture after the internal combustion described herein) out of the vehicle. The second exhaust line 315 may be in communication with an additional component 326 (i.e., another vehicle component such as, e.g., a connector for attaching any external device requiring pressurized air, a pneumatically powered vehicle component such as a differential lock, a pressurized air reservoir, or the like) to provide the pressurized air. In various embodiments, the additional component 326 in communication with the second exhaust line 315 may be removable from or integrated within the vehicle. In some embodiments, the second exhaust line 315 (e.g., being or having additional exhaust line) may be connected to a waste gate configured for releasing the pressurized air from the cylinder 322 to outside of the vehicle for a predetermined amount of time or a predetermined number of piston stroke cycles within the cylinder 322 to ensure that unwanted or excess fuel and air mixture residue (e.g., from the combustion) is expelled out of the vehicle before the pressurized air is provided the driver or the vehicle for use.

The system 300 may include a plurality of valves 310A-D at the connections to, respectively, the fuel and air mixture intake line 306, the air intake line 307, the first exhaust line 314, and the second exhaust line 315. The plurality of valves 310A-D may be controlled by, e.g., one or more switches (similar to, respectively, the first switch 232 and the second switch 234 shown in and described herein with respect to FIG. 2) and/or a controller (similar to the controller 116 shown in and described herein with respect to FIG. 1) connected to the one or more switches. The plurality of valves 310A-D may be controlled to switch positions as needed to perform the operations described herein with respect to FIG. 2 (e.g., to generate the force or torque to move the vehicle in the fuel and air mixture configuration, and to generate and provide the pressurized air from, e.g., the cylinder 322 in the air-only configuration).

FIG. 4 is an illustration of a system (or an apparatus) 400 for providing pressurized air from a vehicle. The system 400 may be similar, at least in part, to the system 300 shown in and described herein with respect to FIG. 3. The system 400 may include a cylinder 422 and a piston 424 disposed within the cylinder 422. The cylinder 422 and the piston 424 may be similar to, respectively, the cylinder 322 and the piston 324 shown in and described herein with respect to FIG. 3. The system 400 may include an intake line 418 and an exhaust line 420. The intake line 418 and the exhaust line 420 may be similar, at least in part, to, respectively, the intake line 318 and the exhaust line 320 shown in and described herein with respect to FIG. 3. The system may include a plurality of valves 410A-D. The plurality of valves 410A-D may be similar to the plurality of valves 310A-D shown in and described herein with respect to FIG. 3. The system may include a fuel and air mixture intake line 406, an air intake line 407, a first exhaust line 414, and a second exhaust line 415. The fuel and air mixture intake line 406, the air intake line 407, the first exhaust line 414, and the second exhaust line 415 may be similar to, respectively, the fuel and air mixture intake line 306, the air intake line 307, the first exhaust line 314, and the second exhaust line 315 shown in and described herein with respect to FIG. 3. The second exhaust line 415 may be connected to an additional component 426 (similar to the additional component 326 shown in and described herein with respect to FIG. 3).

In various embodiments, the system may include an intake valve 410E and an exhaust valve 410F. The intake valve 410E and the exhaust valve 410F may open or close the connections between the cylinder 422 and, respectively, the intake line 418 and the exhaust line 420 and provide additional control for the operations described herein, e.g., with respect to FIGS. 2 and 3 to generate and provide the pressurized air (as well as for the conventional operation of turning an internal combustion engine having the system 400 by igniting the fuel and air mixture in all of the cylinders within the internal combustion engine). The plurality of valves 410A-D as well as the intake valve 410E and the exhaust valve 410F may be controlled automatically in response to the air-only configuration described herein being activated (i.e., controlled automatically by an electronic control unit (ECU) (similar to the ECU 118 shown in and described herein with respect to FIG. 1) and/or a controller (similar to the controller 116 shown in and described herein with respect to FIG. 1)). In some embodiments, the ECU and/or the controller may automatically control the plurality of valves 410A-D as well as the intake valve 410E and the exhaust valve 410F (e.g., by implementing a specific opening and closing schedule of the plurality of valves 410A-D as well as the intake valve 410E and the exhaust valve 410F as needed) so as to achieve a predetermined rate or amount of the pressurized air to be delivered from the cylinder 422. The predetermined rate or amount may correspond to a required rate or amount sufficient for one of various purposes including filling a tire, enabling a pneumatically powered device such as a differential lock, or the like.

Furthermore, for example, the amount of the pressurized air to be delivered from the cylinder 422 may be controlled via control (e.g., by the ECU and/or the controller) of one or more of the plurality of valves 410A-D as well as the intake valve 410E and the exhaust valve 410F (e.g., by controlling the timing of the opening or closing of a valve, the amount of time a valve stays open or close, or the like). Moreover, the RPM (revolutions per minute) related to an engine (e.g., for the crankshaft 230 of the engine 202 shown in and described herein with respect to FIG. 2) may be adjusted (i.e., increased or decreased)—electronically (e.g., via an electronic control unit (ECU), or the like) or mechanically (e.g., via engagement of or disengagement from an accelerator/gas pedal on the vehicle by a user, or the like)—based on a user input which may be obtained via a user interface to adjust (i.e., increase or decrease) the rate of the pressurized air delivered from the cylinder 422.

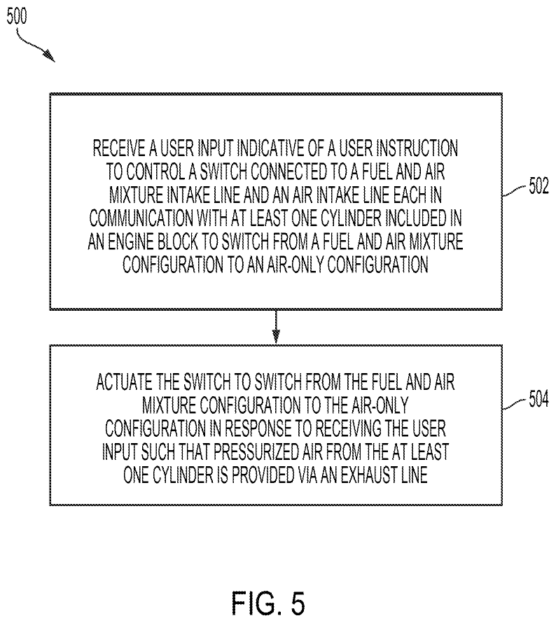

Turning to FIG. 5, a method 500 for providing pressurized air from a vehicle is disclosed. In various embodiments, the method 500 may be implemented via a plurality of instructions (e.g., a software program) stored on a memory and accessed and processed by a processor (e.g., an electronic control unit (ECU) on the vehicle similar to, e.g., the ECU 118 shown in and described herein with respect to FIG. 1) to perform the various steps of the method 500.

In step 502, the method 500 includes receiving a user input indicative of a user instruction to control a switch connected to a fuel and air mixture intake line and an air intake line each in communication with at least one cylinder included in an engine block from a fuel and air mixture configuration to an air-only configuration (e.g., from the fuel and air mixture configuration to the air-only configuration described herein with respect to FIGS. 2-4). In various embodiments, the user input may be received by a user interface.

In step 504, the method 500 includes actuating the switch to switch from the fuel and air mixture configuration to the air-only configuration in response to receiving the user input such that pressurized air from the at least one cylinder is provided via an exhaust line as a crankshaft rotatably mounted on the engine block is rotated to provide the air to the at least one cylinder via the air intake line, pressurize the air within the at least one cylinder, and release the pressurized air from the at least one cylinder via the exhaust line-similarly as described herein with respect to FIGS. 2-4. In some embodiments, actuating the switch to switch from the first switch configuration to the second switch configuration includes stopping providing the fuel and air mixture to the at least one cylinder for a predetermined duration of time to conserve a predetermined amount of fuel. Moreover, in some embodiments, actuating the switch to switch from the first switch configuration to the second switch configuration includes causing the switch to stay in the second switch configuration for a predetermined duration of time to generate a predetermined amount of the pressurized air.

Where used throughout the specification and the claims, “at least one of A or B” includes “A” only, “B” only, or “A and B.” Exemplary embodiments of the apparatus, the system, and the method described herein have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments (e.g., including a singular element where multiple elements are described and/or multiple elements where a singular element is described, etc.) that reasonably fall within the scope of the advancement to the art hereby contributed, and that that scope shall not be restricted, except in light of the appended claims and their equivalents.

What is claimed is:

1. An apparatus for providing pressurized air from a vehicle, the apparatus comprising:
an engine block including a plurality of cylinders;
a plurality of pistons each disposed within a respective one of the plurality of cylinders;
a crankshaft rotatably mounted on the engine block;
a plurality of connecting rods each having a first end and a second end, the first end rotatably connected to the crankshaft and the second end coupled to a respective one of the plurality of pistons;
a fuel and air mixture intake line in communication with at least one cylinder of the plurality of cylinders;
an air intake line in communication with the at least one cylinder;
an exhaust line in communication with the at least one cylinder;
a switch that switches between a fuel and air mixture configuration and an air-only configuration, the fuel and air mixture configuration corresponding to a first switch configuration that allows a fuel and air mixture to be provided to the at least one cylinder via the fuel and air mixture intake line to enable a combustion and the air-only configuration corresponding to a second switch configuration that allows only air to be provided to the at least one cylinder via the air intake line to generate the pressurized air within the at least one cylinder to be provided via the exhaust line; and
a switch controller connected to the switch and configured to cause the switch to switch between the fuel and air mixture configuration and the air-only configuration based on a user input.

2. The apparatus of claim 1, wherein the switch controller is connected to a user interface configured to receive the user input.

3. The apparatus of claim 1, wherein:
the switch is connected to and configured to control one or more valves configured to open or close at least one of the fuel and air mixture intake line or the air intake line;
the fuel and air mixture configuration of the switch corresponds to a first valve position of at least one valve of the one or more valves that allows the fuel and air mixture to be provided to the at least one cylinder to enable the combustion; and
the air-only configuration of the switch corresponds to a second valve position of the at least one valve that allows only the air to be provided to the at least one cylinder to provide the pressurized air from the at least one cylinder via the exhaust line.

4. The apparatus of claim 1, further comprising:
an intake valve disposed at an intake connection between (i) the fuel and air mixture intake line and the air intake line and (ii) the at least one cylinder, the intake valve configured to open or close a first opening at the intake connection; and
an exhaust valve disposed at an exhaust connection between the exhaust line and the at least one cylinder, the exhaust valve configured to open or close a second opening at the exhaust connection.

5. The apparatus of claim 1, wherein the crankshaft is connected to a starter motor configured to:
cause an initial rotation of the crankshaft; and
cause a continued turning of the crankshaft without any combustion causing the continued turning of the crankshaft.

6. The apparatus of claim 1, further comprising an additional exhaust line in communication with the at least one cylinder.

7. The apparatus of claim 6, wherein the additional exhaust line is connected to a pressurized air reservoir configured to receive and store the pressurized air for a future use.

8. The apparatus of claim 7, wherein the pressurized air reservoir is an air tank integrated within the vehicle.

9. The apparatus of claim 7, wherein the pressurized air reservoir is an air tank removable from the vehicle.

10. The apparatus of claim 6, wherein the additional exhaust line is connected to a pneumatically powered vehicle component for powering or actuating the pneumatically powered vehicle component.

11. The apparatus of claim 10, wherein the pneumatically powered vehicle component is a differential lock.

12. The apparatus of claim 6, wherein the additional exhaust line is connected to a waste gate configured for releasing the pressurized air from the at least one cylinder to outside of the vehicle for a predetermined amount of time or a predetermined number of piston stroke cycles within the at least one cylinder.

13. The apparatus of claim 1, further comprising:
a controller configured to control a stroke of the piston disposed within the at least one cylinder; and
an electronic control unit (ECU) on or within the vehicle connected to the controller and configured to:
receive data indicative of an instruction to achieve a requested rate or amount of the pressurized air to be delivered from the at least one cylinder, and
cause the controller to control the stroke of the piston disposed within the at least one cylinder to achieve the requested rate or amount of the pressurized air to be delivered from the at least one cylinder.

14. A system for providing pressurized air from a vehicle, the system comprising:
an engine including:
an engine block including a plurality of cylinders having, respectively, a plurality of pistons therein,
a crankshaft rotatably mounted on the engine block,
a plurality of connecting rods each having a first end and a second end, the first end rotatably connected to the crankshaft and the second end coupled to a respective one of the plurality of pistons,
a fuel and air mixture intake line in communication with at least one cylinder of the plurality of cylinders,
an air intake line in communication with the at least one cylinder, and
an exhaust line in communication with the at least one cylinder;
a switch that switches between a fuel and air mixture configuration and an air-only configuration, the fuel and air mixture configuration corresponding to a first switch configuration that allows a fuel and air mixture to be provided to the at least one cylinder via the fuel and air mixture intake line to enable a combustion and the air-only configuration corresponding to a second switch configuration that allows only air to be provided to the at least one cylinder via the air intake line to generate the pressurized air within the at least one cylinder to be provided via the exhaust line; and
an electronic control unit (ECU) on or within the vehicle connected to the engine and the switch and configured to cause the switch to switch between the fuel and air mixture configuration and the air-only configuration based on a user input.

15. The system of claim 14, further comprising a user interface connected to the ECU and configured to receive the user input.

16. The system of claim 14, wherein the user input includes data corresponding to a requested amount of at least one of a fuel or the pressurized air to be, respectively, conserved or generated, wherein the ECU is further configured to cause the switch to stay in the air-only configuration such that the requested amount of the at least one of the fuel or the pressurized air is, respectively, conserved or generated.

17. The system of claim 14, wherein the ECU is further configured to adjust a rate of revolutions per minute (RPM) of the crankshaft to adjust an amount or a rate of the pressurized air generated.

18. A method for providing pressurized air from a vehicle, the method comprising:
receiving, by a user interface, a user input indicative of a user instruction to control a switch to switch from a first switch configuration to a second switch configuration, the switch connected to a fuel and air mixture intake line and an air intake line each in communication with at least one cylinder of a plurality of cylinders included in an engine block and each having a piston disposed therein, the first switch configuration corresponding to a fuel and air mixture configuration that allows a fuel and air mixture to be provided to the at least one cylinder via the fuel and air mixture intake line to enable a combustion and the second switch configuration corresponding to an air-only configuration that allows only air to be provided to the at least one cylinder via the air intake line to generate the pressurized air within the at least one cylinder to be provided via an exhaust line in communication with the at least one cylinder; and
actuating, by a controller, the switch to switch from the first switch configuration to the second switch configuration in response to receiving the user input such that the pressurized air from the at least one cylinder is provided via the exhaust line as a crankshaft rotatably mounted on the engine block is rotated to provide the air to the at least one cylinder via the air intake line, pressurize the air within the at least one cylinder, and release the pressurized air from the at least one cylinder via the exhaust line.

19. The method of claim 18, wherein actuating the switch to switch from the first switch configuration to the second switch configuration includes stopping providing the fuel and air mixture to the at least one cylinder for a predetermined duration of time to conserve a predetermined amount of fuel.

20. The method of claim 18, wherein actuating the switch to switch from the first switch configuration to the second switch configuration includes causing the switch to stay in the second switch configuration for a predetermined duration of time to generate a predetermined amount of the pressurized air.
